(19) United States
(12) Patent Application Publication
(10) Pub. No.: US 2022/0301435 A1
(43) Pub. Date: Sep. 22, 2022

(54) METHOD AND SYSTEM FOR V2X ASIL DECOMPOSITION

(71) Applicant: Autotalks Ltd., Kfar Netter (IL)

(72) Inventors: Jeffrey Fefer, Nes Ziona (IL); Ziv Dror, Givaat Ada (IL); Onn Haran, Bnei Dror (IL)

(21) Appl. No.: 17/205,593

(22) Filed: Mar. 18, 2021

(51) Int. Cl. G08G 1/16; B60W 60/00; B60W 30/095; B60W 10/18; B60W 30/09; H04W 4/40

(52) U.S. Cl. CPC G08G 1/161; B60W 60/001; B60W 30/0956; B60W 10/18; B60W 30/09; H04W 4/40; B60W 2556/45; B60W 2420/42; B60W 2420/52

(57) ABSTRACT

Advanced driving assistance system (ADAS) and method for enabling V2X ASIL decomposition for operation in a self-vehicle. The ADAS includes an ADAS unit, a plurality of sensors, a corroboration unit and a state machine. The corroboration unit is configured to ignore road-users detected by one sensor if such road-users are not detected by at least one of the other sensors, and the state machine is configured to apply light braking of the self-vehicle based on an uncorroborated V2X alert on an accident risk, and to adjust the braking after the V2X alert is positively or negatively corroborated.

### FIELD

Subject matter disclosed herein relates in general to vehicle-to-everything (V2X) automotive safety integrity level (ASIL) decomposition, and in particular to advanced driving assistance systems (ADAS) for enabling V2X ASIL decomposition.

### BACKGROUND

V2X communication (or as often used herein, simply “V2X”) can uniquely mitigate collisions with hidden road-users, i.e. road-users that cannot be observed by a driver or by other vehicle sensors due to obstructions (buildings, trees, other vehicles, etc.). Road-users include all sorts of vehicles as well as other entities using the road and equipped with V2X. Information received through V2X can be used to brake a vehicle to avoid an accident.

Any vehicle functionality, hardware or software, which, when failing, may risk human lives, is subject to functional safety certification using the ISO26262 standard. The risk classification grade, called Automotive Safety Integrity Level (ASIL) and running from A (lowest) to (D) highest, is determined based on Hazard Assessment and Risk Analysis (HARA). V2X communication is subject to ISO26262 certification when initiating automatic braking in the vehicle, because wrong or missed braking can risk human lives.

The ASIL grade is determined by three parameters: controllability, exposure and severity. The harder to control the vehicle, the higher the ASIL grade. The translation of braking action intensity to vehicle controllability is not explicitly defined by ISO26262. Instead, the ENSEMBLE industry project analysis results are used as a baseline. ENSEMBLE defines the controllability relation to braking in section A24 of deliverable D2.11. ENSEMBLE defines light braking as decelerations below 3.5 m/sec², moderate braking as decelerations up to 5 m/sec², full braking as decelerations up to 8 m/sec², and severe braking as stronger decelerations.

Achieving a high ASIL grade is costly. For example, the highest grade (ASIL D) requires full redundancy. The decomposition concept was developed in the ISO26262 standard to lower the ASIL grade of system elements by splitting the system operation into different elements with independent failure points. For a simplistic example, an ASIL D element can be achieved by combining two independent ASIL B elements.

A block diagram of a known art ADAS numbered 100 is illustrated in FIG. 1A. ADAS 100 includes an ADAS processing unit 102, a V2X communication unit 104, two or more sensors (e.g. a camera 106, a radar unit 108 and a Lidar unit 110). ADAS processing unit 102 includes a visible object corroboration unit 112 that ignores objects detected by one sensor if such objects are not detected by at least one of the other sensors. Unit 112 ensures that a false detection by one sensor does not trigger an automatic brake. Conditioning the operation by agreement of two independent sensors enables ASIL decomposition. The decomposition lowers the ASIL requirement from all sensors. For example, a camera can settle for ASIL B.

V2X HARA calculation can result in an ASIL C or D requirement, depending on the risk perception of a grading test engineer. The greatest risk of V2X system failure is a false activation of hard braking on a highway, which may trigger a rear-end accident.

Wireless communication functional safety is more complicated than that of a wired link, due to the unpredictable nature of a wireless link. Achieving ASIL C or D is probably impossible without costly redundancy. Decomposition for lowering to ASIL B grade is essential to achieve commercial viability. A straightforward decomposition scheme would be to enhance visible object (or road-user) corroboration unit 112 to consider V2X inputs like inputs of all other sensors. In this scheme, a V2X alert would be raised only if one of the other sensors has observed the road-user. However, this defeats the purpose of V2X, since early braking upon detected hidden road-users will not be possible.

A new decomposition scheme is desired to lower the V2X ASIL grade to B when braking is due to hidden road-users. The aim is to provide ASIL decomposition, while still braking when hidden road-users are detected using V2X.

### SUMMARY

In various embodiments there is provided a method, comprising: in a self-vehicle using V2X communication, receiving a V2X message that includes an alert on an accident risk posed by a road-user detected by V2X; applying light braking; corroborating or not corroborating the accident risk using a self-vehicle sensor; and, if the accident risk is corroborated, applying harder braking than the light braking to prevent an accident related to the accident risk, or, if the accident risk is not corroborated, stopping the light braking, whereby the method provides ASIL decomposition of the V2X communication.

In some embodiments, the accident risk includes a rear-end accident risk or a side accident risk.

In some embodiments, the method is performed using a state machine.

In some embodiments, the ASIL decomposition includes ASIL decomposition of a V2X element to grade B.

In some embodiments, the applying light braking includes applying braking up to 3.5 m/see.

In some embodiments, the accident risk is not corroborated if, after waiting for a pre-determined time period or for a pre-determined distance between the self-vehicle and the road-user, the accident risk is not detected by a self-vehicle sensor.

In some embodiments, the pre-determined time period or the pre-determined distance is calculated based on the accident risk and a field-of-view and detection distance of self-vehicle sensors.

In some embodiments, the method includes performing a plausibility check on the received V2X message prior to applying the light braking, and, if the plausibility check fails, ignoring the accident risk.

In various embodiments there is provided an ADAS installed in a self-vehicle, the ADAS comprising: an ADAS processing unit that includes a corroboration unit; a V2X communication unit configured to receive a V2X message that includes an alert on an accident risk posed by a road-user detected by V2X; a plurality of sensors, wherein at least one sensor is configured to provide an input for corroboration of the V2X alert; and a state machine configured to positively or negatively corroborate the V2X alert, wherein the corroboration unit is configured to ignore the alert if the road-user is not detected by at least one of the other sensors, and wherein the state machine is configured to apply light braking of the self-vehicle based on an uncorroborated V2X alert, and to adjust the braking after the V2X alert is positively or negatively corroborated, whereby the system provides automotive safety integrity level (ASIL) decomposition of the V2X communication.

In some embodiments, the light braking includes braking up to 3.5 m/see.

In some embodiments, the at least one sensor is configured to provide the input for corroboration of the V2X alert in a pre-determined time period or at a pre-determined distance between the self-vehicle and the road-user.

In some embodiments, the pre-determined time period or the pre-determined distance is calculated based on the accident risk, and a field-of-view and detection distance of self-vehicle sensors.

In some embodiments, the state machine is further configured to perform a plausibility check on the received V2X message prior to the application of the light braking, and, if the plausibility check fails, is further configured to ignore the accident risk.

### BRIEF DESCRIPTION OF THE DRAWINGS

Non-limiting examples of embodiments disclosed herein are described below with reference to figures attached hereto that are listed following this paragraph. Identical structures, elements or parts that appear in more than one figure are generally labeled with a same numeral in all the figures in which they appear. If identical elements are shown but numbered in only one figure, it is assumed that they have the same number in all figures in which they appear. The drawings and descriptions are meant to illuminate and clarify embodiments disclosed herein and should not be considered limiting in any way. In the drawings:

FIG. 1A illustrates a block diagram of a known ADAS;

FIG. 1B illustrates a block diagram of an ADAS adapted to perform hidden road-user corroboration according to presently disclosed subject matter;

FIG. 2 illustrates in a flow chart steps of a method disclosed herein;

FIG. 3 illustrates actions performed by state machine in the ADAS of FIG. 1B;

FIG. 4 illustrates an intersection driving example.

### DETAILED DESCRIPTION

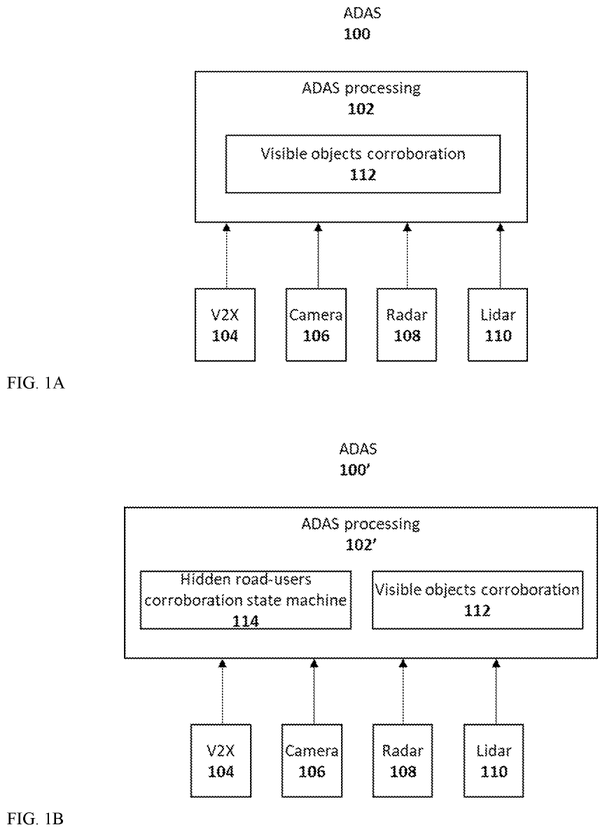

Embodiments disclosed herein teach a new concept for decomposing a V2X driving decision for lowering V2X ASIL to grade B, while enabling braking of a vehicle due to an accident risk posed by a hidden road-user detected by V2X. FIG. 1B illustrates a block diagram of an ADAS numbered 100′ adapted to perform hidden road-user corroboration according to presently disclosed subject matter. ADAS 100′ may include the components of ADAS 100 and in addition a “hidden road-users corroboration state machine” 114 added to ADAS processing unit 102. State machine 114 is used to limit the risk resulting from braking exclusively based on V2X messages in case of a failure, while allowing V2X to brake even if no other sensor observes the road-user. State machine 114 initiates light braking based on an uncorroborated V2X alert, and adjusts the braking accordingly after the V2X alert is positively or negatively corroborated.

The detection of risks is based on road-users V2X transmissions. The self-vehicle parses a received V2X message (from a “received vehicle”), and calculates the future location of the received vehicle. If the self-vehicle current path, speed and acceleration lead to a crash into the received vehicle, then a risk is detected. The detection can be extended to objects detected by sensors of other vehicles, and shared using V2X. The following description continues with reference to road-users, with the understanding that it applies as well to such objects.

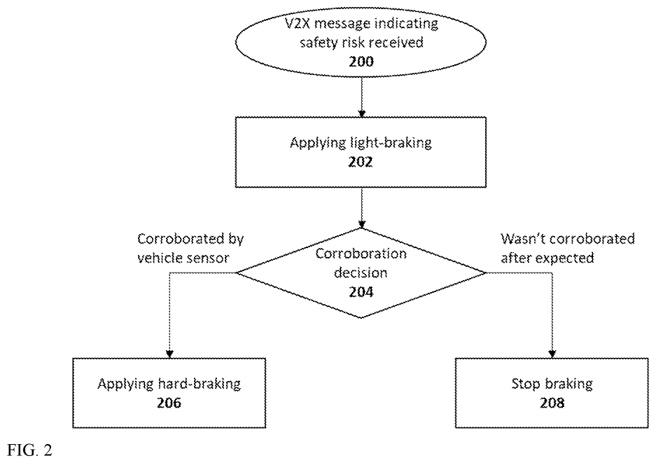

Steps of a method performed using state machine 114 are illustrated in FIG. 2. All operations are performed in each vehicle acting as a self-vehicle. Operation begins at step 200 after reception of a V2X message that indicates a accident risk. The accident risks include and relate to two most common traffic accidents: rear-end and side. Next, in step 202, light braking, under 3.5 m/see is applied. Next, in step 204, the operation waits for a corroboration decision, i.e. corroboration of the accident risk by at least one other self-vehicle sensor. If the risk is corroborated by one or more other self-vehicle sensors in a pre-determined time period or at a pre-determined distance between the self-vehicle and the road-user (calculated based on the accident risk, side or rear-end, and the field-of-view and detection distance of self-vehicle sensors, see below), then hard-braking is applied in step 206. If the risk is not corroborated in a pre-determined time period or at a pre-determined distance between the self-vehicle and the road-user, then operation continues to step 208 and braking is stopped.

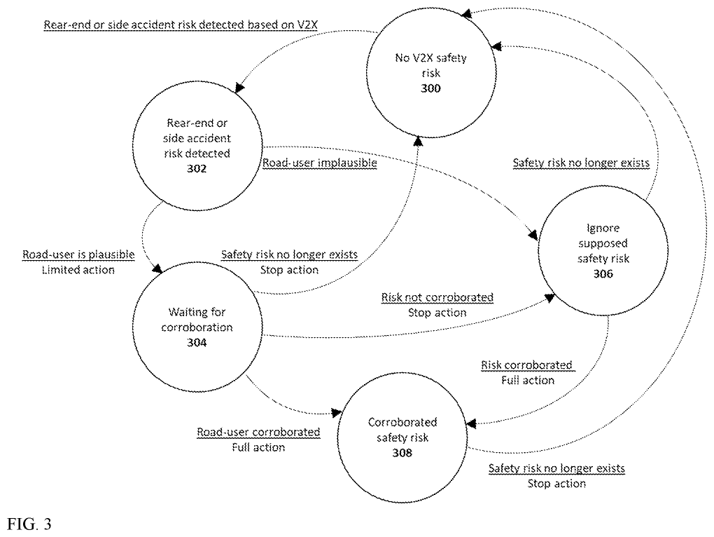

FIG. 3 illustrates actions performed by state machine 114 in more detail. All operations are performed in each vehicle acting as a self-vehicle. The steady-state operation is a state 300 “no accident risk detected”. When a V2X message is received and indicates a accident risk, e.g. meaning a road-user with V2X is in a collision path with the self-vehicle, then the operation moves to a “rear-end or side accident risk detected” state 302. The plausibility of the received V2X message that indicated the accident risk is validated in multiple steps: first, the content of received V2X message fields is checked. For example, if the speed of the road-user as received in the message is 320 km/h, then probably the message is fake. Second, additional V2X access layer plausibility checks can be performed, like comparing measured RSSI values with expected RSSI values, as known in the art. If one plausibility check failed, operation continues from an “ignore supposed accident risk” state 306.

If the plausibility check passed, operation continues to a “waiting for corroboration” state 304 while applying a limited action. With present use-cases, V2X only brakes the vehicle, although some futuristic V2X use-cases would involve steering as well. The action is limited to keep the vehicle under control, hence lowering the ASIL grade.

At state 304, if the accident risk no longer exists, then the action based on V2X is stopped, meaning braking is no longer applied, and the operation returns to state 300. If the road-user was corroborated, meaning the road-user was identified by one of the vehicle sensors, full action is taken, meaning harder braking can be applied, and operation continues to state 308 “corroborated accident risk”. In this state, the operation will move to state 300 when the accident risk no longer exists, and action (i.e. braking) will be stopped.

Upon the transition from state 302 to state 304, the distance between the self-vehicle to the road-user in which the self-vehicle sensors or driver are supposed to detect the accident risk is pre-calculated. If the current distance between the self-vehicle and road-user is equal to or smaller than the pre-calculated distance, and the accident risk is not detected by self-vehicle driver or sensors, then the risk is declared as not corroborated, V2X action is stopped, and operation continues from state 304 to “ignore supposed accident risk” state 306. The distance pre-calculation is a function of the driving scenario and available vehicle sensors. For example, when the road-user arrives from a side, the distance is pre-calculated to be 10 m if the self-vehicle has only a front camera, and to be 40 m if the self-vehicle has side sensors as well. If the risk if real, the self-vehicle should observe the road-user arriving from the side at the pre-calculated distance. When the road-user is ahead of the self-vehicle, the distance is pre-calculated to be a distance driven in 2 seconds. When reaching that distance, a slowdown of the vehicle ahead of self-vehicle should be observed if risk is real.

At state 306, if the accident risk is corroborated exceptionally (in the sense that the window for corroboration ended, and corroboration is not expected at this stage) then full force action is initiated, and operation resumes from a “corroborated accident risk” state 308. At state 308, once a accident risk no longer exists, the operation returns to state 300, and the braking action is stopped.

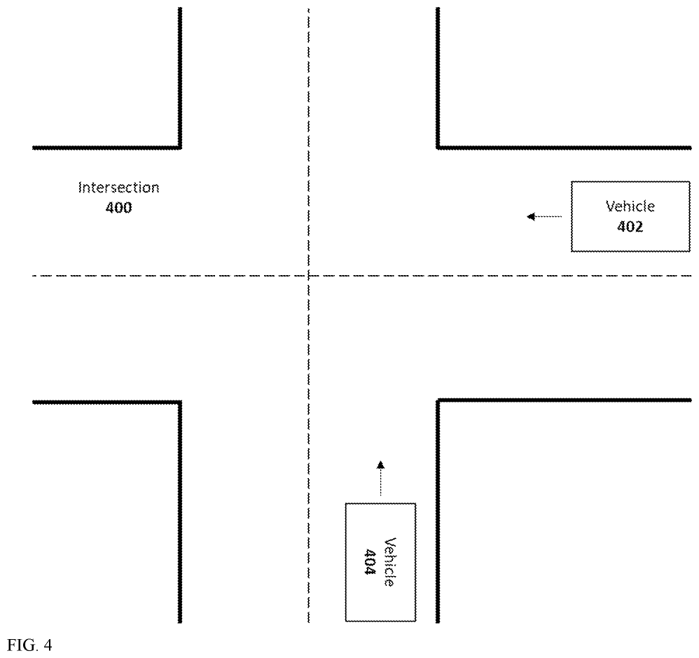

An example of V2X preventing a side accident is illustrated with reference to FIG. 4, which illustrates an intersection driving example. Vehicles 402 and 404 are bursting into an intersection 400. One of these vehicles (no matter which) has the right-of-way, but the other is advancing fast as well, without an intention to stop even though it does not have the right-of-way. Both vehicles have V2X. Initially, both vehicles are driving at a speed 25 m/s, 100 m away from the intersection. The intersection view is obstructed. Both vehicles cannot see each other, but the vehicles are within V2X range and receive each the messages of the other vehicle. Once the vehicles are 75 m from the intersection, with no sign of slowing down, light braking is initiated in both vehicles based on V2X. After 2 seconds, the speed of vehicles drops to 18 m/s, and they are 32 m away from the intersection. At this time, vehicle sensors notice the other vehicle and start full braking at 8 m/sec². At this speed, a vehicle's stopping distance is commonly ˜25 m. The vehicles will stop 7 m before entering the intersection. In the same scenario, without the initial light braking, the braking distance would have been ˜45 m, which would make it impossible to prevent an accident if the two vehicles see each other only when located 32 m from the intersection.

With this scheme, an accident risk detected based on V2X can be mitigated by applying light braking up to 3.5 m/sec². Consequently, the V2X ASIL grade is minimized to ASIL B. The light braking is sufficient to mitigate the accident risk, because V2X addresses safety events well ahead of time. More specifically, V2X can prevent the two major accident types that require emergency braking: rear-end accidents and side accidents. In case of a rear-end accident, the early braking triggered by V2X buys precious time until the driver or vehicle sensors observe the slowdown of the vehicle ahead and start full braking. For a side accident, 2 seconds of V2X light braking shortens the vehicle driven distance by a vehicle length compared to no braking, thus preventing an accident.

FIG. 4 is used also to illustrate an example of a “failed” V2X operation, in the context that showing that a failure event, which may happen very rarely, has bounded and low risk on human life. The failure is reflected by vehicle 402 detecting a non-existing (“ghost”) vehicle as vehicle 404. Vehicle 402 will slow down until reaching 25 m from the intersection. At that point, no other vehicle will be observed, and vehicle 402 will stop the braking action. While false braking is undesired, no harm is done because the light braking greatly reduces the risk of a rear-end accident.

It is appreciated that certain features of the presently disclosed subject matter, which are, for clarity, described in the context of separate examples, may also be provided in combination in a single example. Conversely, various features of the presently disclosed subject matter, which are, for brevity, described in the context of a single example, may also be provided separately or in any suitable sub-combination.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

Some stages of the aforementioned methods may also be implemented in a computer program for running on a computer system, at least including code portions for performing steps of a the relevant method when run on a programmable apparatus, such as a computer system or enabling a programmable apparatus to perform functions of a device or system according to the disclosure. Such methods may also be implemented in a computer program for running on a computer system, at least including code portions that make a computer execute the steps of a method according to the disclosure.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

What is claimed is:

1. A method, comprising: in a self-vehicle using vehicle-to-everything (V2X) communication,
receiving a V2X message that includes an alert on an accident risk posed by a road-user detected by V2X;
applying light braking;
corroborating or not corroborating the accident risk using a self-vehicle sensor; and,
if the accident risk is corroborated, applying harder braking than the light braking to prevent an accident related to the accident risk, or, if the accident risk is not corroborated, stopping the light braking,
whereby the method provides automotive safety integrity level (ASIL) decomposition of the V2X communication.

2. The method of claim 1, wherein the applying light braking includes applying braking up to 3.5 m/sec².

3. The method of claim 1, wherein the accident risk is not corroborated if, after waiting for a pre-determined time period or for a pre-determined distance between the self-vehicle and the road-user, the accident risk is not detected by a self-vehicle sensor.

4. The method of claim 1, wherein the accident risk includes a rear-end accident risk or a side accident risk.

5. The method of claim 1, wherein the method is performed using a state machine.

6. The method of claim 1, wherein the ASIL decomposition includes an ASIL decomposition of a V2X element to grade B.

7. The method of claim 3, wherein the pre-determined time period or the pre-determined distance is calculated based on the accident risk, on a field-of-view and on a detection distance of self-vehicle sensors.

8. The method of claim 3, wherein the pre-determined time period or the pre-determined distance is calculated based on the rear-end or side accident risk, on a field-of-view and on a detection distance of self-vehicle sensors.

9. The method of claim 5, further including performing a plausibility check on the received V2X message prior to applying the light braking, and, if the plausibility check fails, ignoring the accident risk.

10. An advanced driver assistance system (ADAS) installed in a self-vehicle, comprising:
an ADAS processing unit that includes a corroboration unit;
a V2X communication unit configured to receive a V2X message that includes an alert on an accident risk posed by a road-user detected by V2X;
a plurality of sensors, wherein at least one sensor is configured to provide an input for corroboration of the V2X alert; and
a state machine configured to positively or negatively corroborate the V2X alert,
wherein the corroboration unit is configured to ignore the alert if the road-user is not detected by at least one of the other sensors, and wherein the state machine is configured to apply light braking of the self-vehicle based on an uncorroborated V2X alert, and to adjust the braking after the V2X alert is positively or negatively corroborated,
whereby the system provides automotive safety integrity level (ASIL) decomposition of the V2X communication.

11. The ADAS of claim 10, wherein the light braking includes braking under 3.5 m/sec².

12. The ADAS of claim 10, wherein the at least one sensor is configured to provide the input for corroboration of the V2X alert in a pre-determined time period or at a pre-determined distance between the self-vehicle and the road-user.

13. The ADAS of claim 10, wherein the accident risk includes a rear-end accident risk or a side accident risk.

14. The ADAS of claim 10, wherein the ASIL decomposition includes an ASIL decomposition of a V2X element to grade B.

15. The ADAS of claim 10, wherein the state machine is further configured to perform a plausibility check on the received V2X message prior to the application of the light braking, and, if the plausibility check fails, is further configured to ignore the accident risk.

16. The ADAS of claim 12, wherein the pre-determined time period or the pre-determined distance is calculated based on the accident risk, on a field-of-view and on a detection distance of self-vehicle sensors.
